(19) United States
(12) Patent Application Publication
(10) Pub. No.: US 2008/0271856 A1
(43) Pub. Date: Nov. 6, 2008

(54) Daylight Shielding Device

(75) Inventors: Elvira Johanna Maria Paulussen, Eindhoven (NL); Maurice Alexander Hugo Donners, Eindhoven (NL); Theodorus Gerardus Marinus Maria Kappen, Eindhoven (NL); Martien Johan Van Der Meij, Eindhoven (NL); Paulus Quirinus Jozef Nederpel, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/914,244

(22) PCT Filed: May 15, 2006
(86) PCT No.: PCT/IB06/51511

§ 371 Date: Nov. 13, 2007

(30) Foreign Application Priority Data
May 17, 2005 (EP) 05104114.3

(51) Int. Cl. E06B 9/24

(52) U.S. Cl. 160/127

(57) ABSTRACT

A daylight shielding device comprising: a plurality of slats for shielding daylight from a room; a housing for attachment to a window sill or the like, and controls for controlling the position and orientation of the slats, and an illumination device for illuminating said slats. According to the invention, the illumination device and the slats are configured so as to reflect light from said illumination device via said slats into the room. In this way, the slats can be actively used as an indirect illumination source.

The invention relates to a daylight shielding device comprising a plurality of slats for shielding daylight from a room, a housing for attachment to a window sill or the like, and controls for controlling the position and orientation of the slats, and an illumination device for illuminating said slats.

DE10131598 discloses a daylight shielding device comprising organic light-emitting diodes (OLED) attached to the slats. However, OLEDs have a very low radiation intensity and such a configuration has a limited illumination performance.

It is an object of the invention to provide a daylight shielding device wherein the illumination performance is enhanced.

Accordingly, the invention provides a daylight shielding device wherein said illumination device and said slats are configured so as to reflect light from said illumination device via said slats into the room. In particular, using the optical properties of the slats, a more powerful illumination source can be used, while still providing substantially homogeneous lighting.

In one embodiment, said illumination device is attached to said housing so as to illuminate a rear side of said slats when viewed in an outward direction from said room. This embodiment illuminates the slats from a distance, using a light source. In another embodiment, a slat of said plurality of slats is provided with a light-guiding layer attached on a light-blocking layer so as to guide incoming light from said illumination device into said light-guiding layer, said light-guiding layer being arranged to outcouple light at a plurality of positions. In this case, the light sources may typically be LEDs.

The invention will be further elucidated with reference to the drawings, in which

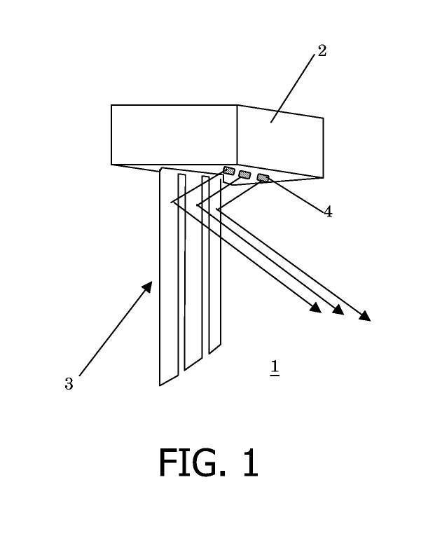

FIG. 1 schematically shows a first embodiment of a daylight shielding device according to the invention;

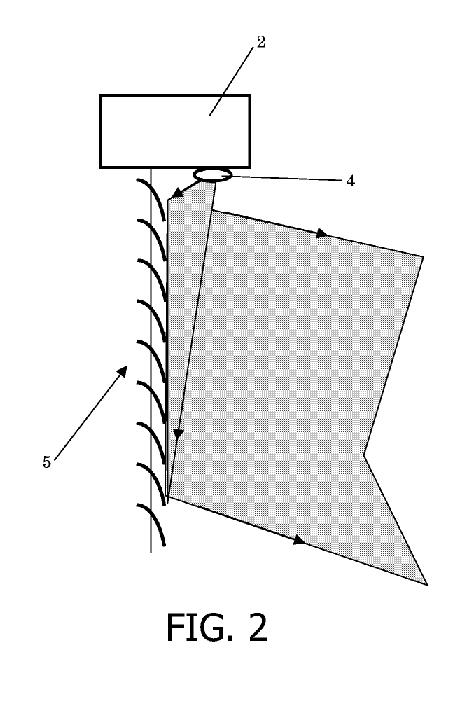

FIG. 2 schematically shows a second embodiment of a daylight shielding device according to the invention;

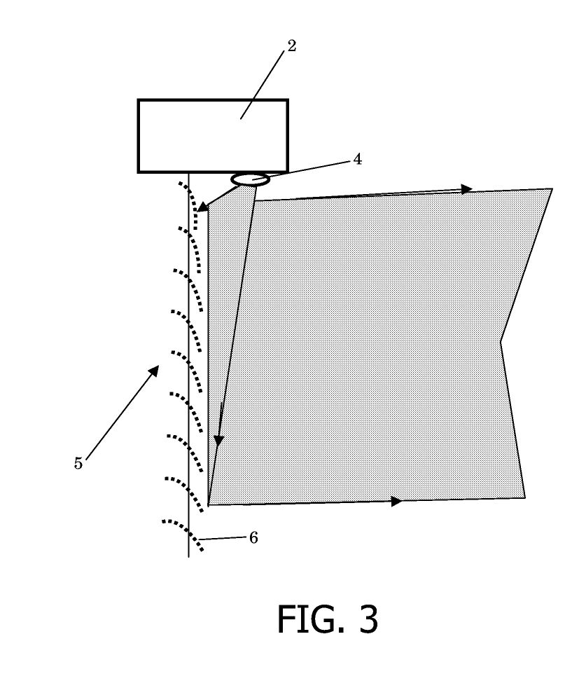

FIG. 3 schematically shows the second embodiment of FIG. 2 in another operating arrangement;

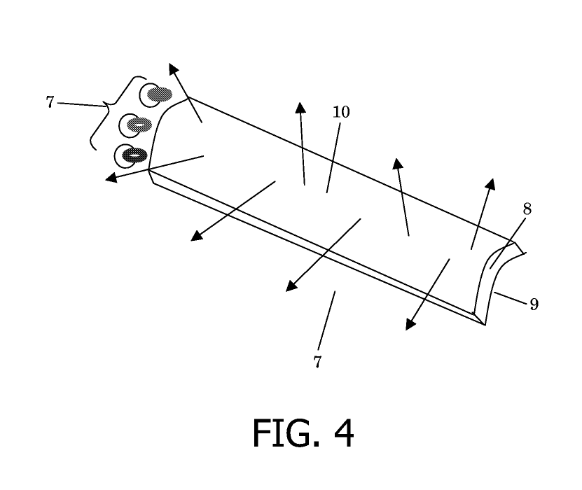

FIG. 4 shows another embodiment of the daylight shielding device;

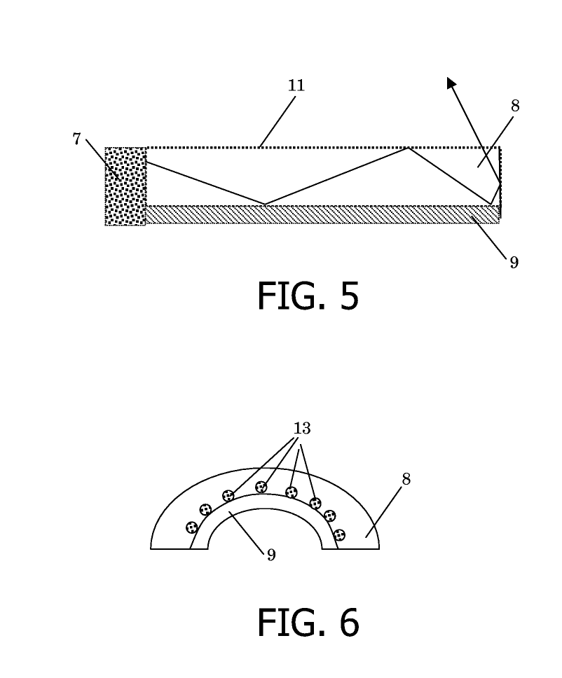

FIG. 5 is a cross-sectional view of the embodiment shown in FIG. 4; and

FIG. 6 is a cross-sectional view of a variation of the embodiment shown in FIG. 4.

FIG. 1 shows a daylight shielding device 1 comprising a housing 2 for attachment to a window sill or the like (not shown), and controls (not shown) for controlling the position and orientation of lamellae or slats 3 as used in conventional devices. The device 1 shown in the Figure typically has vertical slats. In the embodiment shown, an illumination device 4 (typically, a spotlight, narrow-beam light or so-called ‘wall-washer’ with a narrow beam parallel to the illuminated surface, a laser light or light emitted by a LED device) is attached to the housing 2 for illuminating said slats 3. By illuminating the slats 3, a room can be illuminated in a natural way or for decorative purposes, for instance, by choosing a variety of colored light sources. By orienting the slats 3, a directional effect can be obtained so as to direct light in a predetermined direction.

This directional effect can be obtained all the better in the second embodiment illustrated in FIG. 2. This Figure shows horizontal slats 5, used as Venetian blinds, etc. in conventional sun shield devices, wherein the slats 5 are reversed in a direction relative to the normal orientation for shielding daylight. According to the invention, the curvature and orientation of the slats 5 can typically be matched to the illumination light source 4 which may be, for example, a point source or a line source, so that the slats 5 can be used to give a directing effect to a light beam reflected into the room. In a particular embodiment, this is shown in FIG. 3, wherein the relative orientation of the slats 5 is selected so as to converge light reflected on the plurality of slats 5, particularly by orienting the slats 5 at an increasing angle for slats 5 arranged along the vertical. Additionally, a pattern 6 (i.e. a diffusing pattern indicated by dotted lines 6) can be applied on the lamellae 3 in order to achieve a more homogeneous light distribution.

FIG. 4 shows an alternative of the inventive concept, wherein an organic LEDs 7 of Red Green and Blue colors are attached to the slat 5. In this embodiment, the slat 5 and the LEDs 7 are arranged to reflect light from LEDs 7 via the slat 5 into the room, specifically by providing a light-guiding layer 8 attached on a light-blocking layer 9. The light-guiding layer 8 reflects incoming light in the layer via multiple reflections (see FIG. 5) from said illumination device into said light-guiding layer, inter alia, by total internal reflection in the light-guiding layer and by reflection of the light-blocking layer 9. In addition, the light-guiding layer promotes color mixing of the three RGB colors. Furthermore, a microstructure can be provided near the front side 10 as well as near the bottom side so as to achieve (homogeneous) light outcoupling on the front side 10.

FIG. 5 is a schematic side view of the slat shown in FIG. 4. The light-blocking layer 9 is further used for shielding daylight, wherein the face of the light-blocking layer 9 annexed to the light-guiding layer may be reflective. The light-blocking layer 9 may be provided in the form of a coating or film, for instance, by sputtering aluminum on the light-guiding layer, but it may also be provided as a light-blocking substrate which provides structural integrity, particularly in the form of a metal (such as aluminum) slat 5 coated with a transparent layer 8, for instance, of a glass type or a polycarbonate layer, PMMA or the like. The dotted line 11 indicates diffusor elements and/or a microstructure which can promote the outcoupling of light at a plurality of positions in said light-guiding layer by changing the direction of travel of the light beams 12. The number of illuminated slats may vary, as may the texture and coloring of the slats. In the preferred embodiment, each slat is provided with at least one light source attached thereto.

Although FIG. 5 only shows illumination from a single side, LEDs may be arranged to provide illumination from both sides, or, as shown in FIG. 6, also at intermediate positions. This can be arranged by providing the light sources 13 with an adequate electrode structure in intermediate layers, etc. by means of techniques conventionally known in display technology.

The invention has been illustrated with reference to the Figures without being limited thereto. The skilled person will understand that variations and modifications are possible without departing from the scope of the invention. Such variations may comprise additional surface structures for providing specific lighting effects, in addition to coloring of the light-guiding layer, the substrate and/or the light sources. These variations are deemed to fall within the scope of the invention as defined in the appending claims.

1. A daylight shielding device comprising:
a plurality of slats for shielding daylight from a room;
a housing for attachment to a window sill or the like, and controls for controlling the position and orientation of the slats, and
an illumination device for illuminating said slats;
wherein said illumination device and said slats are configured so as to direct light from said illumination device via said slats into the room.

2. A daylight shielding device according to claim 1, wherein said illumination device is attached to said housing to illuminate a rear side of said slats when viewed in an outward direction from said room.

3. A daylight shielding device according to claim 1, wherein said slats are oriented so as to give said reflected light a focusing effect.

4. A daylight shielding device according to claim 1, wherein said illumination device comprises a plurality of light-emitting sources directed towards said slats.

5. A daylight shielding device according to claim 4, wherein said light-emitting sources are LEDs.

6. A daylight shielding device according to claim 4, wherein a slat of said plurality of slats is provided with a light-guiding layer attached on a light-blocking layer so as to guide incoming light from said illumination device into said light-guiding layer, said light-guiding layer being arranged to outcouple light at a plurality of positions in said light-guiding layer.

7. A daylight shielding device according to claim 6, wherein said slats comprise at least one light source attached thereto.

8. A daylight shielding device according to claim 6, wherein said light-guiding layer source is provided with diffusor elements.

9. A daylight shielding device according to claim 6, wherein said light-guiding layer is provided with a light-redirecting microstructure on any one of the top and bottom sides of said layer.

10. A daylight shielding device according to claim 6, wherein said light-guiding layer is provided as a transparent layer on a reflective plate.

11. A daylight shielding device according to claim 6, wherein said light-guiding layer is provided as a transparent layer on a reflective coating.

12. A daylight shielding device according to claim 10, wherein said transparent layer comprises polycarbonate or PMMA, and/or wherein said reflective plate or coating comprises aluminum.
